(19) United States
(12) Patent Application Publication
(10) Pub. No.: US 2013/0321991 A1
(43) Pub. Date: Dec. 5, 2013

(54) OPTICALLY CLEAR ADHESIVE FILM AND ELECTRONIC DEVICE USING THE SAME

(71) Applicant: TMS Co., LTD., Paju-si (KR)

(72) Inventors: Chang Yong LEE, Hwaseong-si (KR); Jun Seo Park, Daejeon (KR)

(73) Assignee: TMS Co., LTD., Paju-si (KR)

(21) Appl. No.: 13/893,689

(22) Filed: May 14, 2013

(30) Foreign Application Priority Data
May 31, 2012 (KR) 10-2012-0058534

(51) Int. Cl. C09J 7/02; G06F 1/16

(52) U.S. Cl. CPC C09J 7/02; G06F 1/1601
USPC 361/679.01; 428/355 R; 428/345; 428/355 N; 428/355 AK; 428/355 AC; 428/68; 428/172

(57) ABSTRACT

An optically clear adhesive film which can be used when an electronic device is remanufactured or parts are reused, and an electronic device using the same are provided. The optically clear adhesive film includes: a UV blocking adhesive layer, and a UV curable adhesive layer which is located on one surface of the UV blocking adhesive layer and is cured when being irradiated with UV light.

### CROSS-REFERENCE TO RELATED APPLICATION

This application claims priority from Korean Patent Application No. 2012-0058534, filed on May 31, 2012 in the Korean Intellectual Property Office, the disclosure of which is incorporated herein by reference in its entirety.

### BACKGROUND

1. Field

Methods and apparatuses consistent with exemplary embodiments relate to an optically clear adhesive film and an electronic device using the same, and more particularly, to an optically clear adhesive film which can be used when an electronic device is remanufactured or its parts are reused, and an electronic device using the same.

2. Description of the Related Art

An optically clear adhesive film refers to a transparent adhesive tape that is optically transparent and can be used to bond parts to each other. For example, the optically clear adhesive film may be used to bond an indium tin oxide (ITO) film or glass when a touch panel is manufactured. The touch panel is manufactured by bonding the ITO film or ITO-coated glass in a multi-layered structure.

In the touch panel, an ITO layer, a driving IC CHIP and a flexible printed circuit board (FPCB) are bonded to one another by means of the optically clear adhesive film. A display having a touch panel is manufactured by bonding such a touch panel to a liquid crystal display (LCD) using the optically clear adhesive film.

However, when the touch panel and the LCD are bonded to each other, bubbles may form on an adhesive surface or foreign substances may enter. Also, the display may malfunction due to several problems such as an electrical fault in driving caused by a defect in the parts. It is common that such a broken display is discarded. However, in the case that only one of the touch panel and the LCD is defective or problems such as bubbles or foreign substances on the adhesive surface arise, if the whole product is discarded, reusable parts are discarded and thus a problem that high-priced parts should be purchased again arises. This is because it is almost impossible to separate parts from the film due to high adhesion of the optically clear adhesive film. One way of separating the parts bonded to each other by means of the optically clear adhesive film is wire-cutting the film and removing the film remaining on surfaces of the parts. However, this method requires all surfaces of the parts to be cleansed and may cause another problem if the film is not completely removed after having been cleansed.

Also, the touch panel and the LCD that are sold as an end product while the display is being manufactured may be defective when they are in use. In this case, it is difficult to separate the touch panel and the LCD from each other even if only one of the touch panel and the LCD is defective, and it is difficult to repair the touch panel and the LCD. Thus, there is no choice but to discard the parts.

### SUMMARY

One or more exemplary embodiments may overcome the above disadvantages and other disadvantages not described above. However, it is understood that one or more exemplary embodiment are not required to overcome the disadvantages described above, and may not overcome any of the problems described above.

One or more exemplary embodiments provide an optically clear adhesive film which can be used when an electronic device is remanufactured or its parts are reused, and an electronic device using the same.

According to an aspect of an exemplary embodiment, there is provided an optically clear adhesive film including: a UV blocking adhesive layer; and a UV curable adhesive layer which is located on one surface of the UV blocking adhesive layer and is cured when being irradiated with UV light.

The UV blocking adhesive layer may be an acrylate photo-cured adhesive layer. The UV blocking adhesive layer may include a UV stabilizer. The UV stabilizer may be at least one of a UV absorbent, a quencher, and a radical scavenger. The UV blocking adhesive layer may include benzotriazole.

Adhesion of the UV curable adhesive layer may be reduced when the UV curable adhesive layer is irradiated with UV light. The UV curable adhesive layer may be a solution-polymerized adhesive layer. The UV curable adhesive layer may include monomer, a polymerization initiator, a post-curing photo initiator, and a photo curable cross-linker to adjust adhesion. The photo curable cross-linker is two or more kinds of photo curable cross-linkers. The post-curing photo initiator may be hydroxy cyclohexyl phenyl ketone. The photo curable cross-linker may be 1,6-Hexanediol diacrylate or trimethylopropane triacrylate.

The UV blocking adhesive layer may enclose a side surface of the UV curable adhesive layer. The UV curable adhesive layer may have an end portion thinner than a center portion.

According to an aspect of another exemplary embodiment, there is provided an electronic device which includes a display panel and a protective panel which is disposed on one surface of the display panel, the display panel and the protective panel being bonded to each other by means of an optically clear adhesive film, the optically clear adhesive film including a UV blocking adhesive layer and a UV curable adhesive layer which is located on one surface of the UV blocking adhesive layer and is cured when being irradiated with UV light.

The protective panel may be a tempered glass layer or a touch panel. The display panel may be an LCD or an OLED display. A surface of the display panel to which the optically clear adhesive film is bonded may be a polarizing film.

A side of the electronic device may be shielded from UV light such that the UV light does not reach the UV curable adhesive layer.

Since the optically clear adhesive film according to exemplary embodiments includes the UV blocking adhesive film and the UV curable adhesive layer, if an electronic device manufactured using the same is defective or out of order, parts can be simply separated from one another by irradiating the electronic device with UV, and thus can be reassembled and is reusable. Therefore, cost-saving effect can be obtained.

### BRIEF DESCRIPTION OF THE DRAWING FIGURES

The above and/or other aspects will be more apparent by describing in detail exemplary embodiments, with reference to the accompanying drawings, in which:

FIG. 1 is a cross section view illustrating an optically clear adhesive film according to an exemplary embodiment;

FIG. 2 is a cross section view illustrating an optically clear adhesive film according to another exemplary embodiment;

FIG. 3 is a cross section view illustrating an optically clear adhesive film according to still another exemplary embodiment; and

FIG. 4 is a cross section view illustrating an electronic device including an optically clear adhesive film according to still another exemplary embodiment.

### DETAILED DESCRIPTION OF EXEMPLARY EMBODIMENTS

Hereinafter, exemplary embodiments will be described in greater detail with reference to the accompanying drawings.

In the following description, same reference numerals are used for the same elements when they are depicted in different drawings. The matters defined in the description, such as detailed construction and elements, are provided to assist in a comprehensive understanding of exemplary embodiments. Thus, it is apparent that exemplary embodiments can be carried out without those specifically defined matters. Also, functions or elements known in the related art are not described in detail since they would obscure the exemplary embodiments with unnecessary detail.

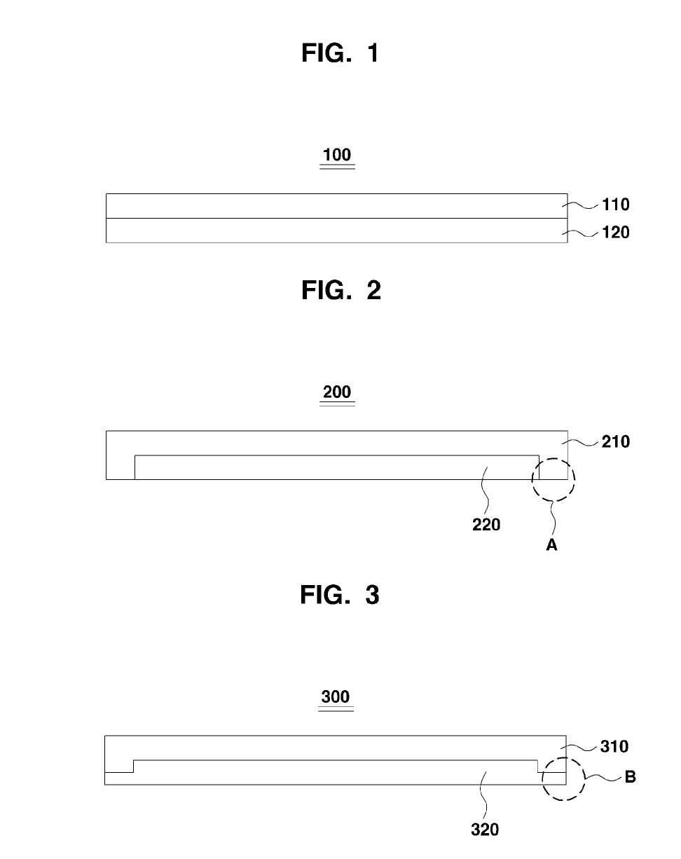

FIG. 1 is a cross section view illustrating an optically clear adhesive film according to an exemplary embodiment. An optically clear adhesive film 100 according to an exemplary embodiment includes an ultraviolet (UV) blocking adhesive layer 110 and a UV curable adhesive layer 120 which is located on one surface of the UV blocking adhesive layer 110 and is cured when being irradiated with UV light. The optically clear adhesive film 100 according to an exemplary embodiment is a film that is used to bond two parts to each other. For example, the optically clear adhesive film may be used to bond a window such as tempered glass or a touch screen to a display panel, or may be used to bond parts of an LCD in an interlayered structure. The optically clear adhesive film should be transparent so that the display panel can be seen therethrough. Therefore, the light transmittance of the optically clear adhesive film may be greater than or equal to 97%.

The optically clear adhesive film 100 according to an exemplary embodiment is an adhesive film which includes the UV curable adhesive layer 120 and the UV blocking adhesive layer 110 which is located on an upper portion of the UV curable adhesive layer. If light enters the UV curable adhesive layer 120 through the upper portion of the UV curable adhesive layer 120, the UV blocking adhesive layer 110 located on the upper portion of the UV curable adhesive layer 120 prevents UV light from reaching the UV curable adhesive layer 120.

The optically clear adhesive film 100 includes the UV curable adhesive layer 120 the adhesion of which is reduced if it is irradiated with UV light, and the UV blocking adhesive layer 110 which protects the UV curable adhesive layer 120 from the UV light. The adhesion of the UV curable adhesive layer 120 is reduced if the UV curable adhesive layer 120 is irradiated with UV light. For example, if the UV curable adhesive layer 120 is irradiated with UV light, the UV curable adhesive layer 120 may be cured and its adhesion may be reduced. That is, if photo curing is performed by irradiating the UV curable adhesive layer 120 with UV light, the UV curable adhesive layer 120 may be cured and thus its adhesion may be reduced.

Accordingly, the UV curable adhesive layer 120 may include monomer and a polymerization initiator, and also, may include a post-curing photo initiator and a photo curable cross-linker to perform photo curing using UV light. The monomer may be acrylate monomer. First, a polymer is formed by reacting the monomer and the polymerization initiator, and the UV curable adhesive layer 120 is formed by adding the post-curing photo initiator and the photo curable cross-linker to the polymer. If the UV curable adhesive layer 120 is irradiated with UV light, curing starts due to the post-curing photo initiator and the UV curable adhesive layer 120 is cured. If the UV curable adhesive layer 120 is cured, adhesion of an interface between the UV curable adhesive layer 120 and parts bonded to the UV curable adhesive layer 120 is reduced such that the optically clear adhesive film 100 and the parts are easily separated from each other.

If an amount of UV light or an amount of photo initiator is changed, a curing speed or a curing intensity of the UV curable adhesive layer 120 is adjusted and the adhesion is also be adjusted. The UV curable adhesive layer 120 may be a solution-polymerized adhesive layer. In this case, the UV curable adhesive layer 120 may be polymerized in a solvent and may further include the post-curing photo initiator and the photo curable cross-linker, and thus may be cured by being irradiated with UV light if necessary.

The UV curable adhesive layer 120 is cured by being irradiated with UV light and its adhesion is changed and thus is lost. Therefore, it is necessary to block the UV light until it is necessary to lose the adhesion and lead separation of the parts. That is, since the UV curable adhesive layer 120 is cured and the adhesion is changed only by being irradiated with UV light, it is necessary to block the UV light in order to cure the UV curable adhesive layer 120 at a desired time.

Therefore, the UV blocking adhesive layer 110 is located on the upper portion of the UV curable adhesive layer 120. The UV blocking adhesive layer 110 may include a UV stabilizer to block UV light.

The UV stabilizer may use a UV absorbent, a quencher, and a radical scavenger as a light stabilizer for example. The UV absorbent is a material that selectively absorbs UV energy, converts it into infrared (IR) energy, that is, thermal energy, and discharges the IR energy. The UV absorbent may be a material selected from the group consisting of hydroxy benzophenone, benzotriazole, and substituted acrylate. The quencher discharges the UV energy as fluorescence, phosphorescence, and heat and may use a nickel compound. The radical scavenger removes radical which is generated during photolytic reaction and suppresses photo-oxidation reaction, rather than absorbing the UV light.

If the UV blocking adhesive layer 110 includes the UV stabilizer and is located on the upper portion of the UV curable adhesive layer 120, the UV blocking adhesive layer 110 prevents UV light from reaching the UV curable adhesive layer 120 and thus may adjust a curing time of the UV curable adhesive layer 120.

Since both the UV blocking adhesive layer 110 and the UV curable adhesive layer 120 of the optically clear adhesive film 100 are adhesive layers and have adhesion, their adhesive surfaces are protected using a release film before the optically clear adhesive film 100 is used, and the release film is removed when the optically clear adhesive film 100 is in use.

FIG. 2 is a cross section view illustrating an optically clear adhesive film according to another exemplary embodiment. An optically clear adhesive film 200 according to another exemplary embodiment includes a UV blocking adhesive layer 210 and a UV curable adhesive layer 220. Hereinafter, a redundant explanation provided in relation to FIG. 1 is omitted.

In FIG. 2, the UV blocking adhesive layer 210 encloses a side surface of the UV curable adhesive layer 220. Since the UV curable adhesive layer 220 should be cured by being irradiated with UV light at a desired time and its adhesion should be reduced, the UV curable adhesive layer 220 may lose its function as an adhesive film if it is exposed to UV light before that time. Accordingly, the UV blocking adhesive layer 210 is located on a top of the UV curable adhesive layer 220, and, if the UV blocking adhesive layer 20 is coated up to the side surface of the UV curable adhesive layer 220, it can prevent input of UV light to the maximum. According to another exemplary embodiment, since the UV blocking adhesive layer 210 is also an adhesive layer and has adhesion, the UV blocking adhesive layer 210 can be adhered to an adherend (not shown) to which the UV curable adhesive layer 220 is adhered, and also, additionally blocks UV light and thus can prevent the UV curable adhesive layer 220 from being cured before the desired time.

As shown in FIG. 2, however, the UV blocking adhesive layer 210 is adhered to the adherend to which the UV curable adhesive layer 220 is adhered on a region A. Accordingly, even when UV light is irradiated to separate the optically clear adhesive film 200, curing is not performed on the region A and thus a residue of the UV blocking adhesive layer 210 may remain on the adherend to which the UV curable adhesive layer 220 is adhered.

Therefore, as shown in FIG. 3, an optically clear adhesive film 300 may be formed to include a UV curable adhesive layer 320 which is thinner on an end portion B than on a center. As the end portion B of the UV curable adhesive layer 320 is thinner, a UV blocking adhesive layer 310 can prevent UV light from entering the UV curable adhesive layer 320 more efficiently. Also, in the case of the optically clear adhesive film 200 shown in FIG. 2, after the UV light is irradiated, a residue of the adhesive may remain on the adherend (not shown) to which the UV curable adhesive layer 220 is adhered due to the presence of the region A. However, in the case of the optically clear adhesive layer of FIG. 3, the end portion of the UV curable adhesive layer 320 is thin and there is hardly any residue remaining.

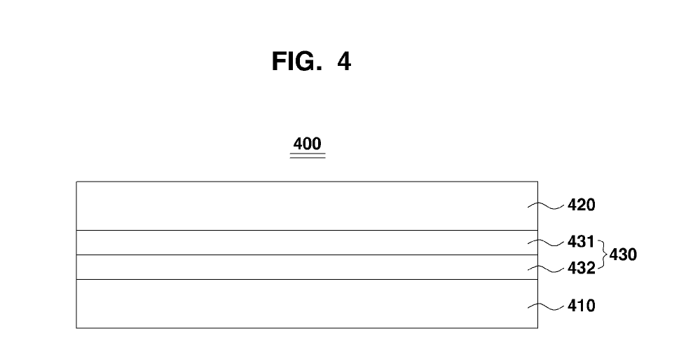

FIG. 4 is a cross section view illustrating an electronic device including an optically clear adhesive film according to still another exemplary embodiment. A redundant explanation provided in relation to FIGS. 1 to 3 is omitted. An optically clear adhesive film 430 according to an exemplary embodiment may be used in an electronic device 400 which includes a display panel 410 and a protective panel 420 to protect one surface of the display panel 410. The protective panel may be interpreted as a panel disposed outside the display panel in a broad sense as well as a panel to protect the display panel, which displays an image. The optically clear adhesive film 430 is located between the display panel 410 and the protective panel 420 and bonds both the panels to each other. Since the protective panel 420 is located outside the display panel 410 and protects the display panel 410, a UV blocking adhesive layer 431 of the optically clear adhesive film 430 is bonded to the protective panel 420, and a UV curable adhesive layer 432 is bonded to the display panel 410.

The protective panel 420 may be, but not limited to, a tempered glass layer or a touch panel. The display panel 410 may be an LCD or an organic light emitting diode (OLED) display. In particular, the OLED display may be an active matrix OLED (AMOLED) display. When the protective panel 420 and the display panel 410 are attached to each other by means of the optically clear adhesive film 430 and are assembled to make an electronic device, the protective panel 420 or the display panel 410 may be found to have a defect or may be out of order when it is in use. At this time, the protective panel 420 and the display panel 410 are bonded to each other by means of the optically clear adhesive film 430 so firmly that they cannot be separated from each other by general physical force.

Accordingly, in this case, if the optically clear adhesive film 430 is irradiated with UV light, the UV curable adhesive layer 432 may be cured and thus adhesion may be reduced. If the adhesion of the optically clear adhesive film 430 is reduced, it is possible to separate parts from each other only by small physical force and thus separate the protective layer 420 and the display panel 410 from each other. Since the UV blocking adhesive layer 431 of the optically clear adhesive film 430 is bonded to the protective panel 420 and the UV curable adhesive layer 432 is bonded to the display panel 410, the optically clear adhesive film 430 may be separated from the display panel 410 with being attached to the protective panel 420 due to the cured UV curable adhesive layer 432. Accordingly, the display panel 410 which is more expensive than the protective panel 420 is repaired and is re-assembled to the electronic device, or may be reused as a part for another device.

In particular, since there is no residue of the UV curable adhesive layer 432 on the surface of the display panel 410 which is separated from the optically clear adhesive film 432 due to the cured UV curable adhesive layer, a separate cleansing process is not required and accordingly the display panel can be repaired or reused directly. The surface of the display panel 410 to which the optically clear adhesive film 430 is bonded may be a polarizing film.

In the electronic device according to an exemplary embodiment, the UV blocking adhesive layer 431 of the optically clear adhesive film 430 is located on a lower portion of the protective panel 420, and the UV curable adhesive layer 432 and the display panel 410 are located under the UV blocking adhesive layer 431. UV light is blocked when the electronic device is manufactured and thus additional blocking of UV light by an element other than the UV blocking adhesive layer is not required. However, when the electronic device is completely manufactured and used, the UV curable adhesive layer 432 may be exposed to the outside from a side of the electronic device. If the UV curable adhesive layer 432 is exposed to the outside, the UV curable adhesive layer may be cured by UV light and thus parts may be separated from each other. In order to prevent this, the side of the electronic device may be shielded from UV light such that the UV light does not reach the UV curable adhesive layer 432.

To achieve this, the side of the electronic device may be covered by a metal or black cover that does not allow UV light to pass therethrough. If the electronic device is defective or is out of order, the cover is removed from the side of the electronic device and the electronic device is irradiated with UV light or exposed to sunlight. Then, the UV light penetrates through the side of the UV curable adhesive layer 432 and cures the UV curable adhesive layer 432. Accordingly, the panels can be easily separated from each other.

Hereinafter, the present disclosure will be explained in detail with reference to examples.

1. Manufacture of a UV Blocking Adhesive

A UV blocking adhesive layer is manufactured in examples 1 to 4 as described below and an adhesive layer of a comparison example in which a UV stabilizer is not added is manufactured in the same way.

### EXAMPLE 1

As monomer of acrylate polymer, 90 parts by weight of butyl acrylate, 6 parts by weight of acrylic acid, 2 parts by weight of acrylamide, and 2 parts by weight of N,N-dimethylacrylamide are input to a 3-neck flask, and are agitated with introduced nitrogen gas for 2 hours. After oxygen is removed from such a polymerization system, 0.2 parts by weight of α-hydroketone photo initiator is added to the mixture, and the mixture is reacted by being irradiated with UV light.

### EXAMPLE 2

As monomer of acrylate polymer, 90 parts by weight of 2-ethylhexylacrylate, 6 parts by weight of acrylic acid, 2 parts by weight of acrylamide, and 2 parts by weight of N,N-dimethylacrylamide are reacted with one another as in example 1.

### EXAMPLE 3

As monomer of acrylate polymer, 92 parts by weight of 2-ethylhexylacrylate, 4 parts by weight of acrylic acid, 2 parts by weight of acrylamide, and 2 parts by weight of glycidylmethacrylate are reacted with one another as in example 1.

### EXAMPLE 4

As monomer of acrylate polymer, 94 parts by weight of 2-ethylhexylacrylate, 2 parts by weight of acrylic acid, 2 parts by weight of acrylamide, and 2 parts by weight of glycidylmethacrylate are reacted with one another as in example 1.

### COMPARISON EXAMPLE

As monomer of acrylate polymer, 88 parts by weight of butyl acrylate, 8 parts by weight of acrylic acid, 2 parts by weight of acrylamide, and 2 parts by weight of N,N-dimethylacrylamide are input to a 3-neck flask, and are agitated with introduced nitrogen gas for 2 hours. After oxygen is removed from such a polymerization system, 0.2 parts by weight of α-hydroketone photo initiator is added the mixture, and the mixture is reacted by being irradiated with UV light.

A UV blocking adhesive layer is manufactured by adding TINUVIN 1130 (a product name, a compound of α-3-(3-(2H-benzotriazol-2-yl)-5-tert-butyl-4-hydroxyphenyl)propionyl-ω-hydroxypoly(oxyethylene); and α-3-(3-(2H-benzotriazol-2-yl)-5-tert-butyl-4-hydroxyphenyl)propionyl-ω-3-(3-(2H-benzotriazol-2-yl)-5-tert-butyl-4-hydroxyphenyl)propionyloxypoly(oxyethylene)) of BASF, which is a UV absorbent, to the adhesive except for the comparison example as a UV stabilizer as described in table 1 below, and cross-linking and curing it, and it is checked whether UV penetrates through an actinometer or not.

TABLE 1

| | | | | | Comparison |
|---|---|---|---|---|---|
| | Example 1 | Example 2 | Example 3 | Example 4 | Example |
| monomer | 90 parts by | 90 parts by | 92 parts by | 94 parts by | 88 parts by |
| | weight of | weight of 2- | weight of 2- | weight of 2- | weight of |
| | butyl | ethylhexylacrylate, | ethylhexylacrylate, | ethylhexylacrylate, | butyl |
| | acrylate, 6 | 6 parts | 4 parts | 2 parts | acrylate, 8 |
| | parts by | by weight of | by weight of | by weight of | parts by |
| | weight of | acrylic acid, 2 | acrylic acid, 2 | acrylic acid, 2 | weight of |
| | acrylic acid, 2 | parts by | parts by | parts by | acrylic acid, 2 |
| | parts by | weight of | weight of | weight of | parts by |
| | weight of | acrylamide, | acrylamide, | acrylamide, | weight of |
| | acrylamide, | and 2 parts by | and 2 parts by | and 2 parts by | acrylamide, |
| | and 2 parts by | weight of N, | weight of | weight of | and 2 parts by |
| | weight of N, | N- | glycidylmeth | glycidylmeth | weight of N, |
| | N- | dimethylacryl | acrylate | acrylate | N- |
| | dimethylacryl | amide | | | dimethylacryl |
| | amide | | | | amide |
| Photo | 0.2 parts by | 0.2 parts by | 0.2 parts by | 0.2 parts by | 0.2 parts by |
| initiator | weight of α- | weight of α- | weight of α- | weight of α- | weight of α- |
| | hydroketone | hydroketone | hydroketone | hydroketone | hydroketone |
| | photo | photo | photo | photo | photo |
| | initiator | initiator | initiator | initiator | initiator |
| UV stabilizer | 10 parts by | 5 parts by | 2.5 parts by | 1 parts by | None |
| | weight of | weight of | weight of | weight of | |
| | TINUVIN | TINUVIN | TINUVIN | TINUVIN | |
| | 1130 | 1130 | 1130 | 1130 | |
| UV | 0 | 0 | 2 | 50 | 2500 |
| transmittance | | | | | |
| (mj/10 min) | | | | | |
| Adhesion | 900 | 1000 | 1050 | 1200 | 800 |
| (180 degrees | | | | | |
| stripping | | | | | |
| experiment, a | | | | | |
| glass plate) | | | | | |

As shown in table 1, the UV transmissivity of the adhesive layer in examples 1 to 4 in which the UV stabilizer is added is 0, 0, 2, and 50 mj/10 min, respectively, whereas the adhesive layer in the comparison example in which the UV stabilizer is not added shows very high UV transmissivity, 2500 mj/10 min. Therefore, it can be seen that the adhesive layer serves as a UV blocking adhesive layer if the UV stabilizer is added.

2. Manufacture of a UV Curable Adhesive Layer

Hereinafter, a UV curable adhesive layer is manufactured in examples 5 to 10 and adhesion after and before curing is measured.

<Preparation 1> As monomer of acrylate polymer, 80 parts by weight of butyl acrylate, 10 parts by weight of 2-hydroxyethylacrylate, 6 parts by weight of acrylic acid, 2 parts by weight of acrylamide, and 2 parts by weight of N,N-dimethylacrylamide are input, and 100 parts by weight of acetone is input. Then, nitrogen gas is introduced in the mixture and the mixture is agitated for 2 hours. After oxygen is removed from such a polymerization system, 0.1 parts by weight of 2,2′-azobisisobutyronitrile is added to the mixture and temperature is increased to 60° C. Then, the mixture is reacted for 12 hours. By adding ethyl acetate to the reaction solution, an acrylate polymer solution of solid concentration of 25% is obtained (acrylic polymer 1)

<Preparation 2> As monomer of acrylate polymer, 80 parts by weight of 2-ethylhexylacrylate, 10 parts by weight of 2-hydroxyethylacrylate, 6 parts by weight of acrylic acid, 2 parts by weight of acrylamide, and 2 parts by weight of N,N-dimethylacrylamide are input, and 100 parts by weight of acetone is input. Then, nitrogen gas is introduced in the mixture and the mixture is agitated for 2 hours. After oxygen is removed from such a polymerization system, 0.1 parts by weight of 2,2′-azobisisobutyronitrile is added to the mixture and temperature is increased to 60° C. Then, the mixture is reacted for 12 hours. By adding ethyl acetate to the reaction solution, an acrylate polymer solution of solid concentration of 25% is obtained (acrylic polymer 2).

Hydroxy cyclohexyl phenyl ketone, which is a post-curing photo initiator, and 1,6-Hexanediol diacrylate, which is a photo curable cross-linker 1 or trimethylopropane triacrylate, which is a photo curable cross-linker 2, are input to acrylic polymer 1 and acrylic polymer 2, which are obtained by preparation 1 and preparation 2. Table 2 illustrates examples 5 to 10.

TABLE 2

| | | | | | | Example |
|---|---|---|---|---|---|---|
| | Example 5 | Example 6 | Example 7 | Example 8 | Example 9 | 10 |
| Acrylic polymer | 1 | 2 | 1 | 2 | 1 | 2 |
| Coating thickness (μm) | 80 | 80 | 80 | 80 | 80 | 80 |
| Cross linker 1 (part by | 1 | 1 | | | 0.5 | 0.5 |
| weight) | | | | | | |
| Cross linker 2 (part by | | | 1 | 1 | 0.5 | 0.5 |
| weight) | | | | | | |
| Post-curing photo | 0.5 | 0.5 | 1 | 1 | 1.5 | 1.5 |
| initiator (part by | | | | | | |
| weight) | | | | | | |
| Adhesion before curing | 1200 | 1100 | 1200 | 1100 | 1200 | 1100 |
| (180 degrees stripping | | | | | | |
| experiment, glass | | | | | | |
| plate) | | | | | | |
| Adhesion after | 400 | 350 | 320 | 300 | 300 | 200 |
| curing (180 degrees | | | | | | |
| stripping experiment, | | | | | | |
| glass plate) | | | | | | |
| Adhesion before curing | 1000 | 950 | 1000 | 950 | 1100 | 950 |
| (180 degrees stripping | | | | | | |
| experiment, polarizing | | | | | | |
| film) | | | | | | |
| Adhesion after | 300 | 250 | 230 | 200 | 200 | 200 |
| curing (180 degrees | | | | | | |
| stripping experiment, | | | | | | |
| polarizing film) | | | | | | |

Examples 5 to 10 show good adhesion before curing such as 1100 to 1200, and show low adhesion after curing. Therefore, it can be seen that the optically clear adhesive film of the present disclosure is an optical film that is easy to separate after curing. In particular, example 10 shows the lowest adhesion after curing and it is estimated that the optically clear adhesive film of example 10 is easiest to separate by UV light.

That is, examples 9 and 10 have the greatest disparity between the adhesion before curing and the adhesion after curing, 900, and it is determined that cross-linking and curing are performed more than the case in which two or more types of cross linkers are used, and thus the greatest disparity between the adhesion before curing and the adhesion after curing occurs. In example 9, since acrylic polymer 1 is used, adhesion is high, but adhesion after curing is lower than in examples 5 to 8. Also, example 9 shows a great disparity between the adhesion before curing and the adhesion after curing and thus is deemed to show good characteristics of the UV curable agent layer.

Also, as a result of testing adhesion with respect to a polarizing film instead of the glass plate, examples 5 to 10 show good adhesion ranging from 1100 to 950 before curing. Since the adhesion is reduced to 200 to 300 after curing, it can be seen that the optically clear adhesive film of the present disclosure is an optical film that is easy to separate from the polarizing film after curing. In particular, example 9 shows the highest adhesion before curing in the adhesion experiment using the polarizing film, but shows reduced adhesion after curing. Therefore, example 9 shows the greatest disparity of 900 between the adhesion before curing and the adhesion after curing, and it is estimated that the UV curable adhesive layer of example 9, which is adhered to the polarizing film, is also easy to separate by UV curing. The foregoing exemplary embodiments and advantages are merely exemplary and are not to be construed as limiting the present inventive concept. The exemplary embodiments can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. An optically clear adhesive film comprising:
a UV blocking adhesive layer; and
a UV curable adhesive layer which is located on one surface of the UV blocking adhesive layer and is cured when being irradiated with UV light.

2. The optically clear adhesive film as claimed in claim 1, wherein the UV blocking adhesive layer is an acrylate photo-cured adhesive layer.

3. The optically clear adhesive film as claimed in claim 1, wherein the UV blocking adhesive layer comprises a UV stabilizer.

4. The optically clear adhesive film as claimed in claim 3, wherein the UV stabilizer is at least one of a UV absorbent, a quencher, and a radical scavenger.

5. The optically clear adhesive film as claimed in claim 1, wherein the UV blocking adhesive layer comprises benzotriazole.

6. The optically clear adhesive film as claimed in claim 1, wherein adhesion of the UV curable adhesive layer is reduced when the UV curable adhesive layer is irradiated with UV light.

7. The optically clear adhesive film as claimed in claim 1, wherein the UV curable adhesive layer is a solution-polymerized adhesive layer.

8. The optically clear adhesive film as claimed in claim 1, wherein the UV curable adhesive layer comprises monomer, a polymerization initiator, a post-curing photo initiator, and a photo curable cross-linker.

9. The optically clear adhesive film as claimed in claim 8, wherein the photo curable cross-linker is two or more kinds of photo curable cross-linkers.

10. The optically clear adhesive film as claimed in claim 8, wherein the post-curing photo initiator is hydroxy cyclohexyl phenyl ketone.

11. The optically clear adhesive film as claimed in claim 8, wherein the photo curable cross-linker is at least one of 1,6-Hexanediol diacrylate and trimethylopropane triacrylate.

12. The optically clear adhesive film as claimed in claim 1, wherein the UV blocking adhesive layer encloses a side surface of the UV curable adhesive layer.

13. The optically clear adhesive film as claimed in claim 1, wherein the UV curable adhesive layer has an end portion thinner than a center portion.

14. An electronic device which comprises a display panel and a protective panel which is disposed on one surface of the display panel, the display panel and the protective panel being bonded to each other by means of an optically clear adhesive film, the optically clear adhesive film comprising a UV blocking adhesive layer and a UV curable adhesive layer which is located on one surface of the UV blocking adhesive layer and is cured when being irradiated with UV light.

15. The electronic device as claimed in claim 14, wherein the protective panel is a tempered glass layer or a touch panel.

16. The electronic device as claimed in claim 14, wherein the display panel is an LCD or an OLED display.

17. The electronic device as claimed in claim 14, wherein a surface of the display panel to which the optically clear adhesive film is bonded is a polarizing film.

18. The electronic device as claimed in claim 14, wherein a side of the electronic device is shielded from UV light such that the UV light does not reach the UV curable adhesive layer.
